(19) United States
(12) Patent Application Publication
(10) Pub. No.: US 2026/0349873 A1
(43) Pub. Date: Nov. 5, 2026

(54) ERROR DETECTION

(71) Applicant: Samsung Electronics Co., Ltd., Suwon-si (KR)

(72) Inventor: Dongjo Park, Suwon-si (KR)

(21) Appl. No.: 19/390,058

(22) Filed: Nov. 14, 2025

(30) Foreign Application Priority Data
May 2, 2025 (KR) 10-2025-0058497

(51) Int. Cl. G06F 11/10

(52) U.S. Cl. CPC G06F 11/1064; G06F 11/1016; G06F 11/1068

(57) ABSTRACT

An electronic device includes a micro controller unit (MCU) module, and a nonvolatile memory device external to the MCU module. The MCU module includes cache memory, and an error detection module configured to detect an error on data received from the nonvolatile memory device in units of the size of a cache line of the cache memory.

### CROSS-REFERENCE TO RELATED APPLICATION

This application is based on and claims priority under 35 U.S.C. §119 to Korean Patent Application No. 10-2025-0058497, filed on May 2, 2025, in the Korean Intellectual Property Office, the entirety of which is incorporated by reference herein.

### BACKGROUND

Recently, automotive industry is rapidly transitioning to software-defined vehicles (SDVs). SDV can remotely update the software installed in a vehicle or expand new functions through an over-the-air (OTA) function, which means that the vehicle can continuously evolve like a smartphone. In response to these environmental changes, the code size of software installed in vehicles continues to increase.

To accommodate the increasing code size, code execution structures that utilize external memory are becoming more common instead of existing built-in memory-based structures. In particular, serial NOR flash, which provides fast random access and high stability, is being widely adopted as external memory for vehicle semiconductors, and thus, the structure that directly executes software codes in an execute in place (XiP) method is becoming popular.

### SUMMARY

The XiP method, discussed above, may be associated with challenges in ensuring code integrity. For example, electrical noise or surges that may occur while reading code data from the external memory may cause 1-bit errors, which may cause a system to enter a fault state or reboot when an incorrect instruction code is transmitted to a central processing unit (CPU). Because it is desirable for vehicle devices to have high stability, such errors can lead to fatal system failures.

Some aspects of the present disclosure provide electronic devices that may flexibly respond to software updates without an additional code static random access memory (SRAM) required for acquisition of integrity. Also described are, for example, operating methods of the electronic devices, and micro controller unit (MCU) modules included in vehicle electronic devices.

According to some implementations of the present disclosure, there is provided an electronic device including an MCU module, and a nonvolatile memory device provided outside the MCU module, wherein the MCU module includes cache memory, and an error detection module configured to detect an error on data received from the nonvolatile memory device in units of the size of a cache line of the cache memory.

According to some implementations of the present disclosure, there is provided an operating method of an MCU module included in a vehicle electronic device, the operating method including starting booting of the MCU module, receiving data from a nonvolatile memory device provided outside the MCU module, transmitting, by the MCU module, the data received from the nonvolatile memory device to a control logic circuit of the MCU module through a second data path, transmitting, by the MCU module, the data received from the nonvolatile memory device to the control logic circuit of the MCU module through a first data path based on booting of a cache memory of the MCU module completed, and detecting, by the MCU module, an error on the data received from the nonvolatile memory device in units of a size of a cache line of the cache memory.

According to some implementations of the present disclosure, there is provided an MCU module included in a vehicle electronic device, the MCU module including cache memory, and an error detection module configured to detect an error on data received from a nonvolatile memory device provided outside the MCU module in units of a size of a cache line of the cache memory.

### BRIEF DESCRIPTION OF THE DRAWINGS

FIG. 1 is a block diagram illustrating an example of an electronic device;

FIG. 2 is a block diagram illustrating an example of an electronic device ;

FIGS. 3 and 4 are block diagrams illustrating an example of a micro controller unit (MCU) module;

FIG. 5 is a block diagram illustrating an example of a first error detection module;

FIG. 6 is a block diagram illustrating an example of a second error detection module;

FIGS. 7 and 8 are diagrams illustrating an example of a cache controller;

FIG. 9 is a diagram illustrating an example of a selection module;

FIG. 10 is a flowchart illustrating an example of an operating method of an MCU module and a nonvolatile memory device; and

FIG. 11 is a block diagram illustrating an example of a vehicle.

### DETAILED DESCRIPTION

First, each of the “modules” described in the present specification may correspond to hardware, software, or a combination of hardware and software included in a computing system. The hardware may include at least one of a programmable component such as a central processing unit (CPU), a digital signal processor (DSP), a graphics processing unit (GPU), a reconfigurable component such as a field programmable gate array (FPGA), and a component providing fixed function such as an intellectual property (IP) block. The software may include at least one of a series of instructions executable by a programmable component and a code convertible into a series of instructions by a compiler or the like, and may be stored in a non-transitory storage medium.

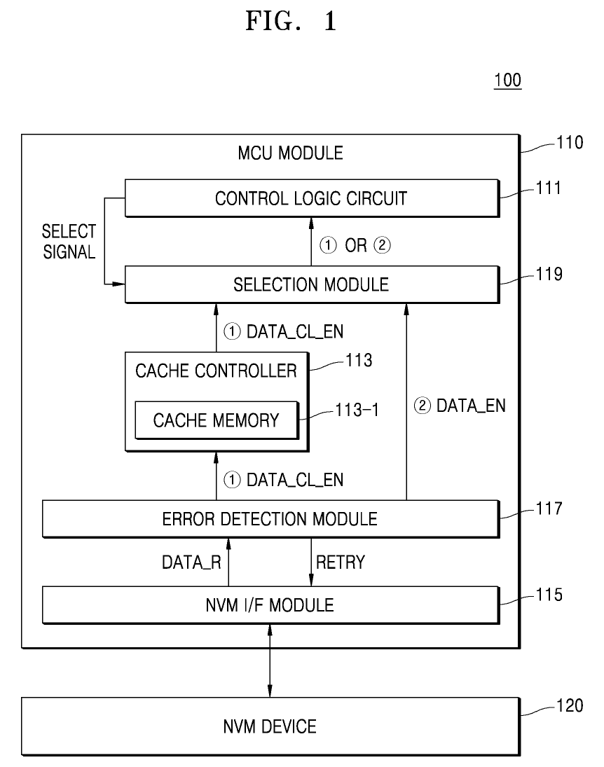

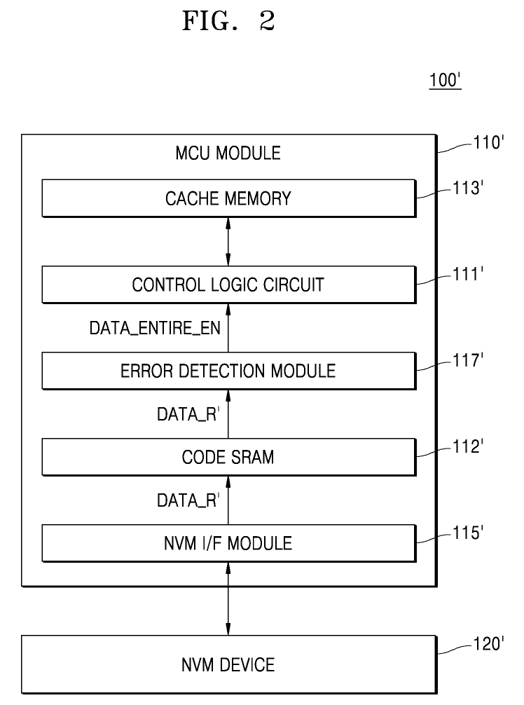

FIG. 1 is a block diagram illustrating an example of an electronic device. FIG. 2 is a block diagram illustrating an electronic device as a comparative example.

An electronic device 100 may be mounted on a vehicle, and, in some implementations, the electronic device 100 may also be referred to as an electronic control unit (ECU).

In some implementations, the electronic device 100 that is an electronic control device may control the overall operation of the vehicle. For example, the electronic device 100 may collect and process measurement information from sensors installed in the vehicle to perform various functions or control a vehicle system.

For example, the electronic device 100 may correspond to at least one of an engine control device, a transmission control device, a brake control device, an airbag control device, a fuel control device, an entertainment system control device, a driving assistance system control device, an energy management device, and a vehicle safety system control device, but the device types are not limited thereto.

The engine control device may control and optimize the operation of a vehicle engine. For example, the engine control device may regulate fuel injection, airflow, ignition timing, exhaust gas treatment, and other engine elements. The transmission control device may manage and control the transmission of the vehicle. For example, the transmission control device may be charge in gear shifting, torque converter clutch control, etc. The brake control device may control a brake system to manage pressure distribution required for stable braking and safety functions (e.g., an anti-lock brake system (ABS) or electronic stability program (ESP). The airbag control device may operate a safety airbag in the event of an accident and analyze information from sensors within the vehicle to activate an airbag at an appropriate time depending on the strength or direction of the accident. The fuel control device may optimize fuel economy and reduce emissions by controlling fuel supply and a fuel mixture ratio. The entertainment system control device may manage audio, video and navigation systems within the vehicle. The driving assistance system control device is used in autonomous vehicles, which are driving assistance systems, and may detect the surrounding environment and control the vehicle through radar, cameras, and sensors. The energy management device may control battery management and energy flow in hybrid and/or electric vehicles. The vehicle safety system control device is used to enhance vehicle safety, and may detect the driving environment through radar, cameras, and sensors and provide warnings to a driver or automatically turn off an engine.

For example, the electronic device 100 may be a vehicle electronic device 100 specialized for performing a specific function of a vehicle.

However, the electronic device 100 is not limited thereto, and the electronic device 100 may be provided in electronic devices such as a digital still camera, a digital video camera, a smartphone, a wearable device, an Internet of Things (IoT) device, a tablet personal computer (PC), a personal digital assistant (PDA), a portable multimedia player (PMP), a navigation device, and the like. In addition, the electronic device 100 may be included in vehicles, furniture, manufacturing facilities, doors, various measuring devices, etc.

Referring to FIG. 1, the electronic device 100 may include a micro controller unit (MCU) module 110 and a nonvolatile memory device 120.

The MCU module 110 may control the overall operation related to the operation of the electronic device 100.

In some implementations, the MCU module 110 may electrically control configurations within the vehicle. For example, the MCU module 110 may generate internal control signals required for various vehicle control operations described above, or perform data processing and calculations for various vehicle control operations described above.

The MCU module 110 may be implemented as software, hardware, or a combination of hardware and software. For example, the MCU module 110 may be an integrated circuit that executes software instructions, and, in some implementations, the MCU module 110 may be referred to as a system on chip (SOC).

Referring to FIG. 1, the nonvolatile memory device 120 may be provided outside, external to, or separate from the MCU module 110. In addition, the nonvolatile memory device 120 may support an execute in place (XiP) function for directly executing software codes. That is, the MCU module 110 may directly execute corresponding software based on data received from the nonvolatile memory device 120 without copying data stored in the nonvolatile memory device 120 to the internal memory (e.g., main memory) of the MCU module 110.

For example, the nonvolatile memory device 120 may be serial NOR flash memory that supports an XiP function. As the MCU module 110 may directly access byte-by-byte program execution code data stored in the serial NOR flash memory, the MCU module 110 may directly execute the program execution code data stored in the serial NOR flash memory without copying the program execution code data.

However, memory and device configurations are not limited thereto, and the nonvolatile memory device 120 may be arbitrary nonvolatile memory that supports an XiP function. For example, the nonvolatile memory device 120 may be implemented as parallel NOR flash memory, electrically erasable programmable read-only memory (EEPROM), OneNAND flash memory that combines the advantages of NOR and NAND, magnetoresistive random-access memory (MRAM), ferroelectric random-access memory (FRAM), etc.

Hereinafter, the nonvolatile memory device 120 will be described primarily with reference to the serial NOR flash memory, but it is noted that the memory type is not limited thereto.

In addition, hereinafter, data DATA_R received from the nonvolatile memory device 120 may refer to program execution code data. The program execution code data may mean data including a set of instructions that may be interpreted and executed by a control logic circuit 111 of the MCU module 110. The corresponding data are stored in the nonvolatile memory device 120 in the form of an instruction set or bytecode executable by the MCU module 110 and may include software or firmware for performing functions of the electronic device 100.

For example, the program execution code data may include a series of instructions related to a vehicle control operation, sensor data processing, a user interface operation, or communication protocol processing, and the program execution code data may be stored in the nonvolatile memory device 120 and then directly executed by the MCU module 110 in an XiP manner.

Referring to FIG. 1, the MCU module 110 may include the control logic circuit 111, a cache controller 113, a nonvolatile memory interface module 115, an error detection module 117, and a selection module 119.

The control logic circuit 111 may generate internal control signals or perform computational processing of the electronic device 100. For example, the control logic circuit 111 may include a central processing unit (CPU) that interprets and executes instructions for controlling the operation of the electronic device 100.

The cache controller 113 may include cache memory 113-1. The cache memory 113-1 may temporarily store data repeatedly referenced by the control logic circuit 111. The cache controller 113 may be configured to provide data stored in the cache memory 113-1 to the control logic circuit 111 or store data in the cache memory 113-1.

The MCU module 110 may further include main memory in addition to the cache controller 113 and/or the cache memory 113-1. For example, the main memory that is a main memory device may be dynamic random access memory (DRAM). In addition, the control logic circuit 111 may retrieve useful or necessary data from the main memory when the useful or necessary data is not in the cache memory 113-1.

The nonvolatile memory interface module 115 may provide an interface for data transmission/reception with the nonvolatile memory device 120 provided outside the nonvolatile memory interface module 115, and for example, may operate based on a serial peripheral interface (SPI), a quad serial peripheral interface (QSPI), or the like.

For example, the nonvolatile memory interface module 115 may be configured to receive program execution code data from the externally provided nonvolatile memory device 120 and transmit the program execution code data to the cache memory 113-1 or the control logic circuit 111.

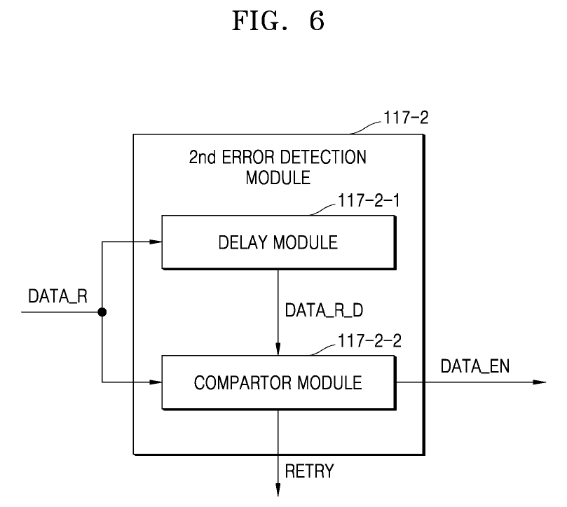

The error detection module 117 may detect an error in the data DATA_R received from the nonvolatile memory device 120 by comparing data DATA_R corresponding to original data with delayed data DATA_R_D (FIG. 6).

In addition, the error detection module 117 may detect an error in the data DATA_R received from the nonvolatile memory device 120 in units of the size of a cache line of the cache memory 113-1.

The cache line may be a basic unit of data transmitted at one time from the cache memory 113-1 or data stored at one time in the cache memory 113-1, and refer to a fixed-size unit data block that the cache memory 113-1 processes at one time. For example, the cache line may be a basic unit of data transmission between the control logic circuit 111 and the cache controller 113. The size of the cache line may be pre-determined, for example, the size of the cache line may be 16 bytes, 32 bytes, 64 bytes, or 128 bytes.

In addition, the data DATA_R received from the nonvolatile memory device 120 may include a plurality of data sets.

Each of the plurality of data sets may include sub data corresponding to the size of the cache line of the cache memory 113-1 and error detection data corresponding to the sub data.

The error detection data may mean data for verifying data integrity of the data received from the nonvolatile memory device 120. For example, the error detection data may be generated in a checksum or cyclic redundancy check (CRC) manner, and through such error detection data, the error detection module 117 may detect forgery or modulation of the data DATA_R.

In some implementations, the nonvolatile memory device 120 may generate error detection data corresponding to the sub data. The nonvolatile memory device 120 may divide data into units corresponding to the size of the cache line of the cache memory 113-1 and generate error detection data for each sub data. Thereafter, the nonvolatile memory device 120 may insert detection data corresponding to each sub data to form a plurality of data sets and transmit the plurality of data sets to the MCU module 110.

In some implementrations, the nonvolatile memory device 120 may insert first detection data corresponding to first sub data to form a first data set and transmit the first data set to the MCU module 110. Next, a second data set may be formed by inserting second detection data corresponding to the second sub data, and the second data set may be provided to the MCU module 110. That is, whenever the nonvolatile memory device 120 transmits each sub data to the MCU module 110, the nonvolatile memory device 120 may insert detection data corresponding to the sub data to form a data set and provide the data set to the MCU module 110.

The error detection module 117 may perform an error detection operation on the data DATA_R received from the nonvolatile memory device 120 through the nonvolatile memory interface module 115.

Based on the error detection result that there is no error in the received data DATA_R, the error detection module 117 may be configured to transmit error-free data to the control logic circuit 111.

Referring to FIG. 1, a path through which the error detection module 117 transmits the error-free data to the control logic circuit 111, may include two data paths. The first data path may be a data path that passes through the cache controller 113 (or cache memory 113-1), and the second data path may be a path that does not pass through (or bypasses) the cache controller 113 (or cache memory 113-1).

Based on the error detection result that there is an error in the received data DATA_R, the error detection module 117 may be configured to request the nonvolatile memory device 120 to re-transmit the corresponding data.

Referring to FIG. 1, when an error is detected in the received data DATA_R, the error detection module 117 may output a retry trigger signal RETRY to the nonvolatile memory interface module 115, and the nonvolatile memory interface module 115 may operate to re-receive the corresponding data from the nonvolatile memory device 120.

Here, the data that is the target of a re-reception request indicated by the retry trigger signal RETRY may be a corresponding data set in which an error was detected, and, in some implementations, the data that is the target of the re-reception request may be all of a plurality of data sets corresponding to the entire program execution code data.

The selection module 119 may be configured to transmit error-free data from the error detection module 117 to the control logic circuit 111 through a selected data path based on a selection signal SELECT SIGNAL of the control logic circuit 111.

Referring to FIG. 1, in response to the selection signal SELECT SIGNAL of the control logic circuit 111, the selection module 119 may be configured to provide data DATA_EN on which an error detection operation has been performed, from the error detection module 117 to the control logic circuit 111, or to provide data DATA_CL_EN stored in the cache memory 113-1 to the control logic circuit 111.

For example, the selection module 119 may provide data DATA_CL_EN to the control logic circuit 111 in units of data blocks corresponding to the size of a cache line, which is an operation unit of the cache memory 113-1, through the first data path that passes through the cache controller 113 (or cache memory 113-1). In addition, or alternatively, the selection module 119 may directly provide data DATA_EN to the control logic circuit 111 through a second data path that does not pass through the cache controller 113 (or cache memory (113-1).

Referring to FIG. 2, unlike the electronic device 100, in an electronic device 100’ according to the comparative example, an MCU module 110’ includes a code SRAM 112’.

Electrical surge that may occur during the process of transmitting data from the nonvolatile memory device 120’ may cause a 1-bit error in the data. This may cause the control logic circuit 111’ to enter a fault state, which may eventually cause the control logic circuit 111’ to be rebooted. These problems may be serious defect factors in a vehicle electronic device 100’ that requires high stability.

That is, even though the nonvolatile memory device 120’ supports the XiP function, the MCU module 110’ needs to include a separate code SRAM 112’ to verify the data integrity of data received from the nonvolatile memory device 120’.

As shown in FIG. 2, the MCU module 110’ may perform an error detection operation on data DATA_R’ received from the error detection module 117’ after copying data DATA_R’ received from the nonvolatile memory device 120’ to the code SRAM 112’ first. At this time, the received data DATA_R’ includes program execution code data and a single checksum value corresponding to the entire program execution code data. After error detection is performed, the error detection module 117’ may provide error detection result data DATA_ENTIRE_EN to the control logic circuit 111’.

Thus, the MCU module 110’ needs to include a separate code SRAM 112’ corresponding to the size of the entire program execution code data.

However, when software is updated and the size of the entire program execution code data changes, the storage capacity of the code SRAM 112’ also needs to increase. However, as the code SRAM 112’ is a hardware configuration, there is a problem that it is difficult to respond flexibly.

Referring to FIGS. 1 and 2, unlike the electronic device 100’ according to the comparative example, the electronic device 100 may verify data integrity for the data DATA_R received from the nonvolatile memory device 120 without, in some implementations, utilizing the cache memory 113-1 or using the separate code SRAM 112’.

For example, in some implementations, when software is updated and the size of the entire program execution code data changes, the electronic device 100 (and/or MCU module 110) may flexibly respond thereto.

In addition, in some implementations, by inserting error detection data corresponding to each sub data corresponding to the size of the cache line, the read bandwidth of the nonvolatile memory device 120 may be enhanced compared to a method of inserting error detection data corresponding to each instruction unit of the program execution code data.

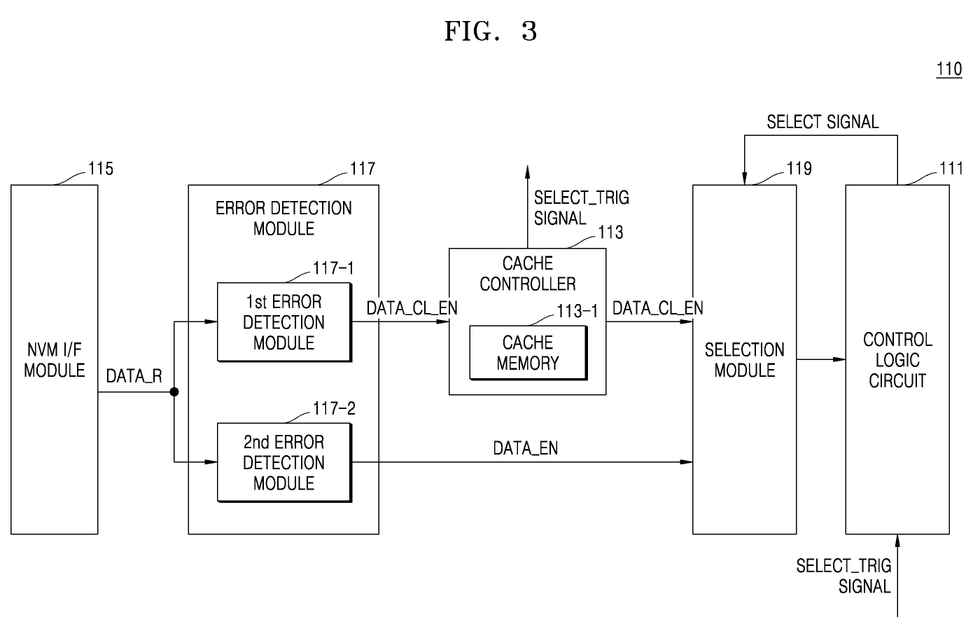

The operation of the electronic device 100 will be described in detail with reference to FIGS. 3-10.

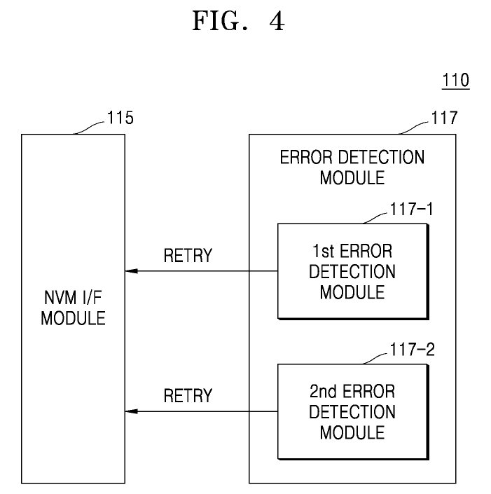

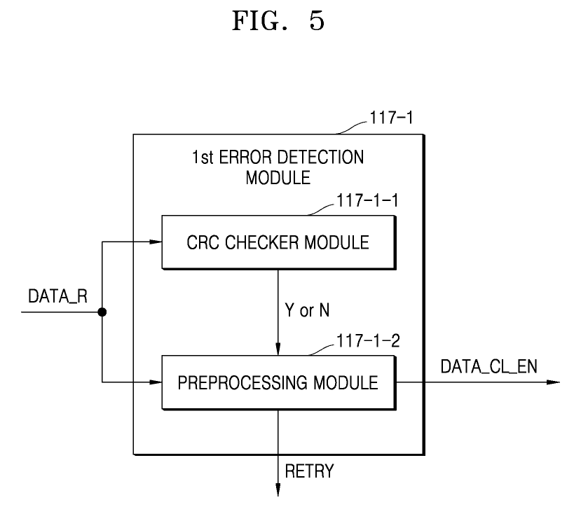

FIGS. 3 and 4 are block diagrams illustrating an example of an MCU module. FIG. 5 is a block diagram illustrating an example of a first error detection module. FIG. 6 is a block diagram illustrating an example of a second error detection module. In the following description, content redundant with the content described with reference to FIG. 1 will be omitted.

Referring to FIG. 3, the error detection module 117 may include a first error detection module 117-1 and a second error detection module 117-2.

Referring to FIGS. 1 and 3, the first error detection module 117-1 and the second error detection module 117-2 may each receive the data DATA_R received from the nonvolatile memory device 120, from the nonvolatile memory interface module 115.

The first error detection module 117-1 may detect an error in the received data DATA_R by using CRC checking.

The second error detection module 117-2 may detect an error in the received data DATA_R by comparing the data DATA_R corresponding to the original data with the delayed data DATA_R_D.

In some implementations, the first error detection module 117-1 may detect an error in the data DATA_R received from the nonvolatile memory device 120 in units of the size of a cache line of the cache memory 113-1.

Referring to FIG. 4, based on an error detection result indicating that there is an error in the received data DATA_R, the first error detection module 117-1 may output a retry trigger signal RETRY to the nonvolatile memory interface module 115.

In addition, based on the error detection result that there is an error in the received data DATA_R, the second error detection module 117-2 may output a retry trigger signal RETRY to the nonvolatile memory interface module 115.

Referring to FIG. 5, the first error detection module 117-1 may include a CRC checker module 117-1-1 and a preprocessing module 117-1-2.

The CRC checker module 117-1-1 may receive the data DATA_R received from the nonvolatile memory device 120, from the nonvolatile memory interface module 115. In addition, the CRC checker module 117-1-1 may perform an error detection operation for each data set based on error detection data corresponding to sub data included in each data set. Here, the error detection data may be, for example, a CRC value.

In some implementations, the CRC checker module 117-1-1 may separate sub data and the CRC value from one data set. The CRC checker module 117-1-1 may calculate a CRC value for separated sub data based on the same polynomial as the polynomial used in the nonvolatile memory device 120. The CRC checker module 117-1-1 may determine that there is no error when they match or that there is an error when they do not match, by comparing the calculated CRC value with the separated CRC value. The CRC checker module 117-1-1 may output a signal or data (represented as “Y” or “N” as an example) to the preprocessing module 117-1-2 to indicate whether an error is detected.

Here, the polynomial may be one of CRC-16, CRC-32, CRC-64, and CRC-128, based on the size of the cache line. That is, a CRC polynomial corresponding to the cache line size may be used.

The preprocessing module 117-1-2 may output a retry trigger signal RETRY of the corresponding data to the nonvolatile memory device 120 based on the error detection operation result of the CRC checker module 117-1-1, or provide data DATA_CL_EN excluding error detection data from the sub data to the cache controller 113.

Here, data DATA_CL_EN may be provided to the cache controller 113 in units of size corresponding to the size of the cache line of the cache memory 113-1.

For example, the preprocessing module 117-1-2 may output the retry trigger signal RETRY of the corresponding data to the nonvolatile memory device 120 based on the error detection operation result of the CRC checker module 117-1-1 indicating that there is an error.

In addition, the preprocessing module 117-1-2 may provide data DATA_CL_EN excluding error detection data from the sub data to the cache controller 113 based on the error detection operation result of the CRC checker module 117-1-1 indicating that there is no error.

Referring to FIG. 6, the second error detection module 117-2 may include a delay module 117-2-1 and a comparison module 117-2-2.

The delay module 117-2-1 may receive the data DATA_R received from the nonvolatile memory device 120, from the nonvolatile memory interface module 115. In addition, the delay module 117-2-1 may output the delayed data DATA_R_D by delaying the received data DATA_R by a pre-determined amount of time.

The comparison module 117-2-2 may receive the data DATA_R received from the nonvolatile memory device 120 and may receive the delayed data DATA_R_D from the delay module 117-2-1. The comparison module 117-2-2 may detect errors in the data DATA_R by comparing the data DATA_R with the delayed data DATA_R_D. Here, the pre-determined time for which the data DATA_R received by the delay module 117-2-1 is delayed, may be, for example, a time within one cycle of the operating clock signal of the MCU module 110.

That is, the second error detection module 117-2 may secure reliability by comparing the data DATA_R corresponding to original data with the delayed data DATA_R_D by comparing the same data with a time difference.

For example, the comparison module 117-2-2 may output a retry trigger signal RETRY of the corresponding data to the nonvolatile memory device 120 based on the comparison result that the data DATA_R and the delayed data DATA_R_D are different from each other.

In addition, the comparison module 117-2-2 may provide data DATA_EN corresponding to the data DATA_R (or the delayed data DATA_R_D) to the selection module 119 based on the comparison result that the data DATA_R and the delayed data DATA_R_D are identical to each other.

Referring back to FIG. 3, the cache controller 113 may output a selection trigger signal SELECT_TRIG SIGNAL to the control logic circuit 111. The control logic circuit 111 may output a selection signal SELECT SIGNAL to the selection module 119 in response to the selection trigger signal SELECT_TRIG SIGNAL.

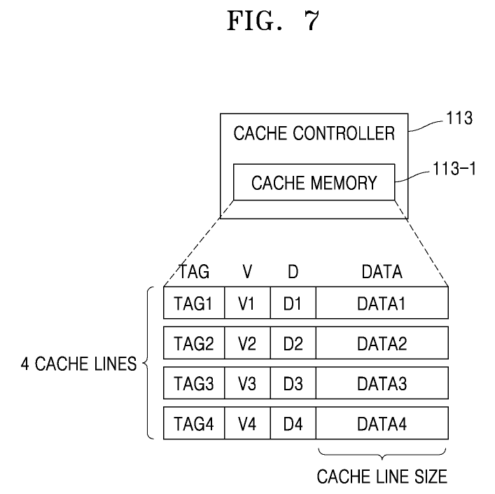

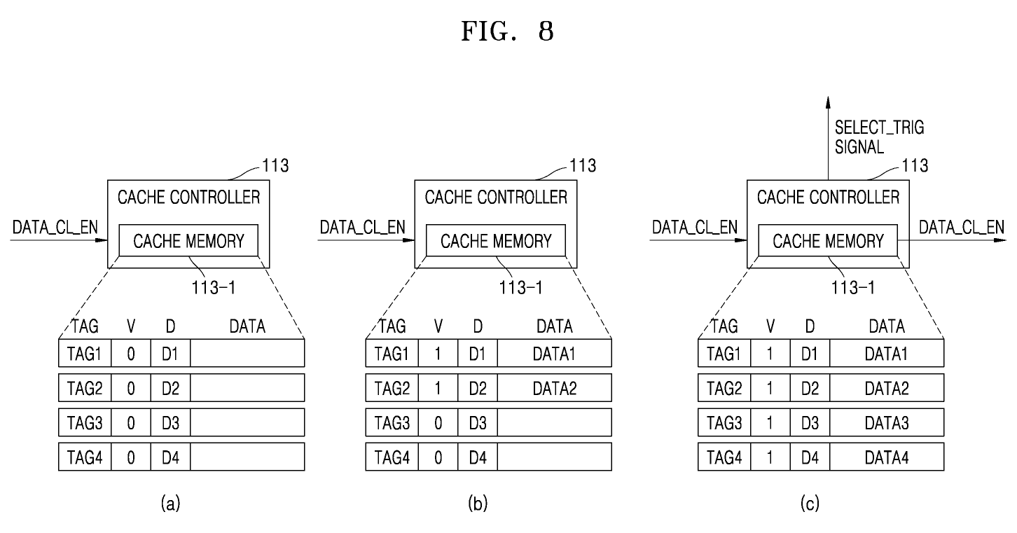

In some implementations, after the cache controller 113 performs an initialization operation, the cache controller 113 may output the selection trigger signal SELECT_TRIG SIGNAL to the control logic circuit 111. This will be explained in detail with reference to FIGS. 7 and 8.

FIGS. 7 and 8 are diagrams illustrating an example of a cache controller. Specifically, FIG. 7 illustrates a cache line structure corresponding to a data structure in which data is stored, in the cache memory 113-1 of the cache controller 113. Referring to FIG. 7, the cache memory 113-1 is illustrated as including four cache lines, but the cache configuration is not limited thereto, and the cache memory 113-1 may include any number of cache lines.

Referring to FIG. 7, each of the cache lines may include a tag TAG, a valid bit V, a dirty bit D, and a data block DATA as components.

The tag TAG is a part of an address and may mean an identification bit to distinguish each cache line.

The valid bit V may be a bit that indicates whether the cache line contains valid data. For example, a valid bit V of 1 may indicate that there is valid data in the corresponding cache line, and a valid bit V of 0 may indicate that there is no valid data in the corresponding cache line.

The dirty bit D may indicate whether the corresponding cache line has been modified relative to main memory. For example, the main memory may be DRAM as a main memory device, and the dirty bit D may be set when the cache controller 113 modifies data of the corresponding cache line, but the data is not yet reflected in the main memory.

In some implementations, unlike those illustrated in FIGS. 7 and 8, cache lines may not include the dirty bit D. For example, when the cache memory 113-1 corresponds to an instruction cache rather than a data cache, the dirty bit D may be omitted from the cache line of the instruction cache. For example, the instruction cache may access stored instructions as read-only without modification, so that the dirty bit D may be unnecessary.

On the other hand, in some implementations, when the cache memory 113-1 is a unified cache that caches both instructions and data, the dirty bit D may be used to track whether the data has been modified.

The data block DATA may represent an actual data block transmitted and received with the control logic circuit 111. Alternatively, the data block DATA may be a data block on which reading or writing is performed by the cache controller 113.

In addition, the size of the cache line described above in FIGS. 1-6 may refer to the size of a data block DATA. For example, the size of the data block DATA may be 16 bytes, 32 bytes, 64 bytes, or 128 bytes. The size of sub data described herein may match this size, e.g., may be 16 bytes, 32 bytes, 64 bytes, or 128 bytes.

FIG. 8 illustrates a data configuration of the cache controller 113 at three time points. Time point (a) corresponds to a point in time when the cache controller 113 starts booting, time point (b) corresponds to a point in time at which the cache controller 113 has not yet completed the initialization operation, and time point (c) corresponds to a point in time at which the cache controller 113 has completed the initialization operation.

Referring to FIG. 8 and time point (a), when the cache controller 113 (or cache memory 113-1) starts booting, all valid bits V stored in the cache memory 113-1 may be set to 0. In addition, the cache controller 113 (or cache memory 113-1) may start reception of data DATA_CL_EN from the first error detection module 117-1.

Referring to FIG. 8 and time point (b), the cache controller 113 may sequentially store data DATA_CL_EN received from the first error detection module 117-1 in the cache lines of the cache memory 113-1. The data DATA_CL_EN may be provided to the cache controller 113 in units of size corresponding to the size of the cache line of the cache memory 113-1.

The cache controller 113 may set the valid bit V of each cache line to 1 when data storage in the corresponding cache line is completed. For example, referring to FIG. 8 and time point (b), when the storage of data DATA1 in the first cache line is completed and the storage of data DATA2 in the second cache line is completed, the valid bit V1 and the valid bit V2 may be set to 1.

Referring to FIG. 8 and time point (c), when the storage of the corresponding data in all cache lines is completed, the initialization operation may be considered completed, and the cache controller 113 may output a selection trigger signal SELECT_TRIG SIGNAL to the control logic circuit 111. For example, referring to FIG. 8C, when the storage of the corresponding data in all of the first to fourth cache lines is completed, all valid bits V1 to V4 may be set to 1, and accordingly, the cache controller 113 may output a selection trigger signal SELECT_TRIG SIGNAL to the control logic circuit 111.

For example, the cache controller 113 may output the selection trigger signal SELECT_TRIG SIGNAL to the control logic circuit 111 based on all valid bits of the cache memory 113-1 being set to 1 or having another predetermined bit value.

The selection trigger signal SELECT_TRIG SIGNAL may be provided to the control logic circuit 111 in the form of an interrupt, and in response to the selection trigger signal SELECT_TRIG SIGNAL, the control logic circuit 111 may preferentially output the selection signal SELECT SIGNAL to the selection module 119. The selection module 119 may provide data DATA_CL_EN from the cache memory 113-1 to the control logic circuit 111 in response to a selection signal SELECT SIGNAL.

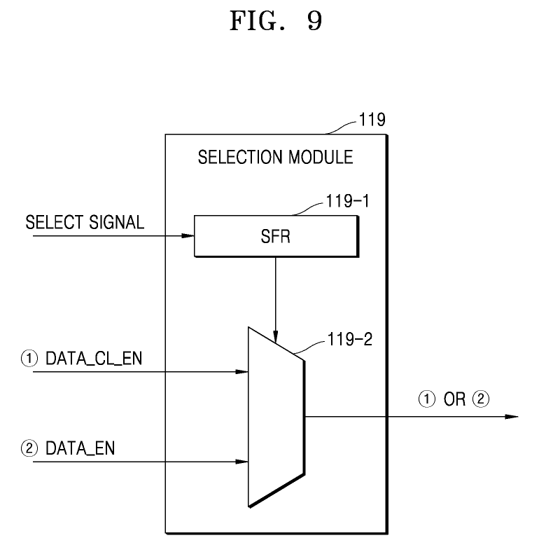

FIG. 9 is a diagram illustrating an example of a selection module. Referring to FIG. 9, the selection module 119 may include a special function register (SFR) 119-1 and a multiplexer 119-2.

Referring to FIGS. 1, 3, and 9, the control logic circuit 111 may be configured to select one of the first data path and the second data path based on the selection signal SELECT SIGNAL.

Here, the first data path may be a data path that passes through the cache controller 113 (or cache memory 113-1), and the second data path may be a path that does not pass through the cache controller 113 (or cache memory 113-1).

The SFR 119-1 may be a register that monitors and controls peripheral functions of the control logic circuit 111. The control logic circuit 111 may activate/deactivate a specific function by storing a value in the SFR 119-1, and the control logic circuit 111 may identify the activation status of a specific function.

Referring to FIG. 9, when the control logic circuit 111 stores a value designating the first data path or the second data path in the SFR 119-1 through the selection signal SELECT SIGNAL through the SFR 119-1, the multiplexer 119-2 may provide the first data path or the second data path based on the value stored in the SFR 119-2.

For example, when the control logic circuit 111 stores a value (e.g., 1) specifying the first data path in the SFR 119-1 through the select signal SELECT SIGNAL, the multiplexer 119-2 may provide data DATA_CL_EN to the control logic circuit 111 through the first data path passing through the cache controller 113 (or cache memory 113-1) according to the value stored in the SFR 119-2.

In addition, when the control logic circuit 111 stores a value (e.g., 0) indicating the second data path in the SFR 119-1 through the select signal SELECT SIGNAL, the multiplexer 119-2 may provide data DATA_EN to the control logic circuit 111 through the second data path that does not pass through the cache controller 113 (or cache memory 113-1) according to the value stored in the SFR 119-2.

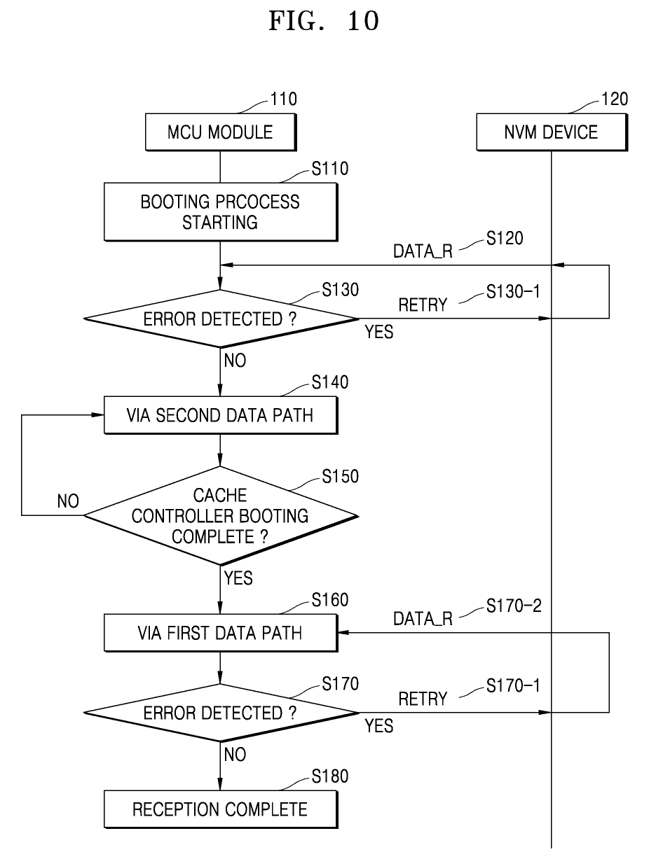

FIG. 10 is a flowchart illustrating an example of an operating method of an MCU module and a nonvolatile memory device. The operating method, as illustrated in FIG. 10, may be performed, for example, in or by the MCU module 110 and nonvolatile memory device 120 of FIG. 1.

In operation S110, the MCU module 110 may start a booting process. Thus, program execution code data stored in the nonvolatile memory device 120 may be requested to nonvolatile memory device 120 outside (e.g., external to or separate from) the MCU module 110. For example, the MCU module 110 may provide a request for the data to the nonvolatile memory device 120.

In operation S120, the MCU module 110 may receive the data DATA_R from the nonvolatile memory device 120 outside the MCU module 110. The nonvolatile memory device 120 may transmit program execution code data to the MCU module 110, and the MCU module 110 may receive the program execution code data as the data DATA_R received from the nonvolatile memory device 120.

In operation S130, the MCU module 110 may generate delayed data by delaying the data DATA_R received from the nonvolatile memory device 120 outside the MCU module 110, and may detect an error in the data DATA_R received from the nonvolatile memory device by comparing the received data DATA_R, which is original data, with the delayed data DATA_R_D.

In operation S130-1, based on the comparison result that the data DATA_R and the delayed data DATA_R_D are different from each other, the MCU module 110 may output a re-transmission request signal RETRY of the data DATA_R to the nonvolatile memory device 120. Thus, the nonvolatile memory device 120 may perform Operation S120 again. Operation S130 may be performed, for example, using the second error detection module 117-2.

In operation S140, based on the comparison result that the data DATA_R and the delayed data DATA_R_D are identical to each other, the MCU module 110 may transmit the data DATA_R received from the nonvolatile memory device 120 through the second data path to the control logic circuit 111 of the MCU module 110.

In operation S150, the MCU module 110 may determine whether the cache memory 113-1 of the MCU module 110 has completed booting.

In operation S160, based on the fact that the cache memory 113-1 of the MCU module 110 has completed booting, the MCU module 110 may transmit the data DATA_R received from the nonvolatile memory device 120 through the first data path to the control logic circuit 111 of the MCU module 110.

Here, the first data path may be a data path that passes through the cache memory 113-1, and the second data path may be a data path that does not pass through the cache memory 113-1.

In operation S170, the MCU module 110 may detect an error in the data DATA_R received from the nonvolatile memory device 120 in units of the size of the cache line of the cache memory 113-1.

In operation S170-1, based on the error detection result that there is an error in the data DATA_R, the MCU module 110 may output a re-transmission request signal RETRY of the data DATA_R to the nonvolatile memory device 120. Thus, in operation S170-2, the nonvolatile memory device 120 may transmit data DATA_R back to the MCU module 110. Operation S170 may be performed, for example, using the first error detection module 117-1.

Here, the data DATA_R that is the target of the re-reception request may be the corresponding data set in which an error was detected, and in some implementations, may be all of a plurality of data sets corresponding to the entire program execution code data.

In operation S180, based on the error detection result that there is no error in the data DATA_R, the MCU module 110 may continue to transmit the data DATA_R received from the nonvolatile memory device 120 through the first data path to the control logic circuit 111 of the MCU module 110, and the reception of the data DATA_R may be completed.

Referring to FIGS. 1-10, in some implementations, unlike the electronic device 100' according to the comparative example, the electronic device 100 may verify data integrity for the data DATA_R received from the nonvolatile memory device 120 without utilizing the cache memory 113-1 or using the separate code SRAM 112'. Thus, when the software is updated and the size of the entire program execution code data changes, the electronic device 100 (and/or MCU module 110) may flexibly respond thereto.

In addition, in some implementations, by inserting error detection data corresponding to each sub data corresponding to the size of a cache line, the read bandwidth of the nonvolatile memory device 120 may be enhanced compared to a method of inserting error detection data corresponding to each instruction unit of program execution code data.

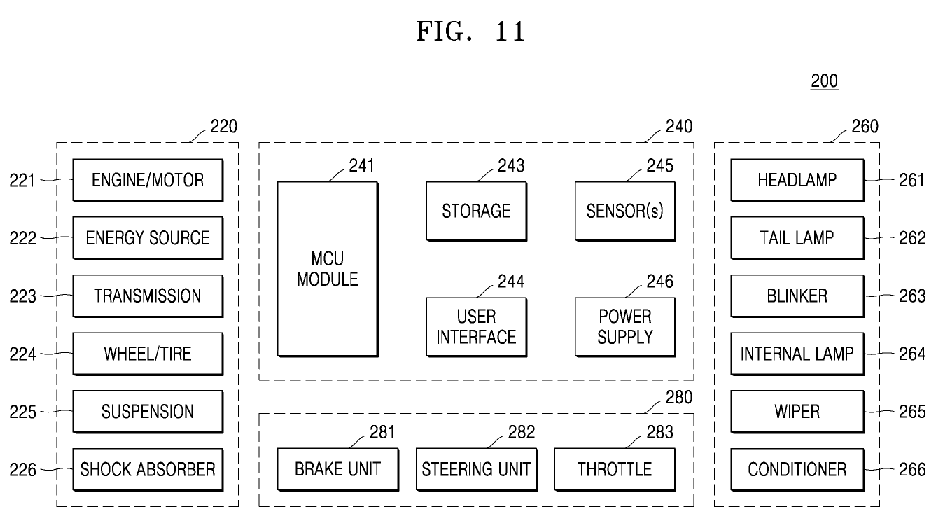

FIG. 11 is a block diagram illustrating an example of a vehicle. Referring to FIG. 11, a vehicle 200 may include a propulsion device 220, an electronic device 240, a peripheral device 260, and a driving device 280.

The propulsion device 220 may include an engine/motor 221, an energy source 222, a transmission 223, a wheel/tire 224, a suspension 225, and a shock absorber 226. The engine/motor 221 may include any combination of an internal combustion engine, an electric motor, a steam engine, and a stirling engine. In some implementations, when the vehicle 200 is a gas-electric hybrid car, the engine/motor 221 may include a gasoline engine and an electric motor. The energy source 222 may be a source of energy that at least partially powers the engine/motor 221, and the engine/motor 221 may convert the energy source 222 into kinetic energy.

The energy source 222 may include at least one of gasoline, diesel, propane, other compressed gas-based fuels, ethanol, solar panels, batteries, and other electrical power sources, as non-limiting examples. In some implementations, the energy source 222 may include at least one of a fuel tank, a battery, a capacitor, and a flywheel. In addition, the energy source 222 may provide energy to other components of the vehicle 200 as well as the engine/motor 221.

The transmission 223 may transmit mechanical power from the engine/motor 221 to the wheel/tire 224. For example, the transmission 223 may include at least one of a gearbox, a clutch, a differential device, and a drive shaft. When the transmission 223 includes drive shafts, the drive shafts may include at least one axle coupled to the wheel/tire 224. The wheel/tire 224 may have various structures for bicycles, motorcycles, four-wheeled vehicles, etc., and may contact the road surface.

The suspension 225 is a device that supports the weight of the vehicle 200, and may adjust the ground clearance of the vehicle 200 from the road surface and also adjust vibration from the road surface transmitted to the vehicle 200. The shock absorber 226 may control spring vibration transmitted from the road surface during driving and help the spring return to its original state. For example, the shock absorber 226 may control the elasticity of the spring by generating a damping force to stop the vibration of the spring. In some implementations, the shock absorber 226 may be included in the suspension 225.

The electronic device 240 may include an MCU module 24, a storage 243, a user interface 244, at least one sensor 245, and a power source 246. The MCU module 241 may control the vehicle 200 and may also be referred to as an electronic control unit (ECU). For example, the MCU module 241 may control the driving of the vehicle 200 by controlling the propulsion device 220 and the driving device 280, and may control the peripheral device 260.

In addition, the MCU module 241 may perform various operations to assist driving of the vehicle 200.

Storage 243 may store data and may include, for example, a nonvolatile semiconductor memory device, a volatile semiconductor memory device, a disk drive, etc.

According to some implementations, the MCU module 241 may correspond to the MCU module 110 described with reference to FIGS. 1-10, and the storage 243 may correspond to the nonvolatile memory device 120 described with reference to FIGS. 1-10.

According to some implementations, when software is updated and the size of the entire program execution code data changes, the MCU module 241 may flexibly respond thereto.

In addition, according to some implementations, error detection data corresponding to sub data corresponding to the size of the cache line may be inserted so that the read bandwidth of the storage 243 may be enhanced compared to a method of inserting error detection data corresponding to each instruction unit of the program execution code data.

The user interface 244 may include an input device for receiving user input and an output device for providing an output signal to a user. For example, the input device may include a key pad, a dome switch, a touch pad, a jog wheel, a jog switch, a microphone, or the like. In addition, the output device may include a speaker and/or buzzer for outputting audio signals, a display device and/or light emitting diode (LED) for outputting video signals, etc.

At least one sensor 245 may include a sensor for detecting the state of the vehicle 200. For example, at least one sensor 245 may include a motion sensor, such as a geomagnetic sensor, an acceleration sensor, a gyro sensor, or a global positioning system (GPS) sensor for estimating the position of the vehicle 200. In addition, at least one sensor 245 may include a sensor for detecting the state surrounding the vehicle 200. For example, at least one sensor 245 may include a RADAR sensor that uses radio signals to detect the presence and/or speed of objects around the vehicle 200, and may include a LIDAR sensor that uses lasers to detect the presence and/or speed of objects around the vehicle 200. In addition, at least one sensor 245 may include at least one image sensor (or a camera module including an image sensor) that photographs the surroundings of the vehicle 200, and the image sensor may provide image data generated by photographing an incoming vehicle to the processing device 242.

The power source 246 may provide power to at least a part of components of the vehicle 200. For example, the power source 246 may include a power generator that generates power by driving the vehicle 200, and may also include a battery for storing power.

The peripheral device 260 may include a headlamp 261, a tail lamp 262, a blinker 263, an internal lamp 264, a wiper 265, and a conditioner 266. The headlamp 261 may be arranged on the front surface of the vehicle 200, and the tail lamp 262 may be arranged on the rear surface of the vehicle 200. The blinker 263 may be arranged on the front surface, the rear surface, and the side surface of the vehicle 200, and the internal lamp 264 may be arranged in a space where a driver is present. The wiper 265 may make a reciprocal motion on glass arranged on the front surface and/or the rear surface of the vehicle 200, and the conditioner 266 may include an air conditioner and/or a heater.

The driving device 280 may include a brake unit 281, a steering unit 282, and a throttle 283. The brake unit 281 may be implemented as a combination of mechanisms configured to decelerate the vehicle 200. For example, the brake unit 281 may use friction to reduce the rotational speed of the wheel/tire 224. The steering unit 282 may be implemented as a combination of mechanisms configured to control the driving direction of the vehicle 200. The throttle 283 may be implemented as a combination of mechanisms configured to control the operating speed of the engine/motor 221. For example, the throttle 283 may regulate the amount of fuel-air mixture gas flowing into the engine/motor 221 and control power and thrust.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination. Operations in the drawings may be performed in a different order to that illustrated.

While certain examples have been particularly shown and described, it will be understood that various changes in form and details may be made therein without departing from the spirit and scope of this disclosure.

What is claimed is:

1. An electronic device comprising:
a micro controller unit (MCU) module; and
a nonvolatile memory device external to the MCU module,
wherein the MCU module comprises:
cache memory, and
an error detection module configured to detect errors in data received from the nonvolatile memory device in units of a size of a cache line of the cache memory.

2. The electronic device of claim 1, wherein the MCU module comprises:
a control logic circuit configured to output a selection signal; and
a selection module configured to, based on the selection signal:
provide data on which an error detection operation has been performed, to the control logic circuit, from the error detection module, or
provide data stored in the cache memory to the control logic circuit.

3. The electronic device of claim 2, wherein the MCU module comprises a cache controller including the cache memory,
wherein the cache controller is configured to, after performing an initialization operation, output a selection trigger signal to the control logic circuit, and
wherein the control logic circuit is configured to output the selection signal in response to the selection trigger signal.

4. The electronic device of claim 3, wherein the cache controller is configured to output the selection trigger signal to the control logic circuit based on all valid bits of the cache memory having a predetermined bit value.

5. The electronic device of claim 1, wherein the data received from the nonvolatile memory device comprises a plurality of data sets, and
wherein each data set of the plurality of data sets comprises:
sub data having a size matching the size of the cache line of the cache memory, and
error detection data corresponding to the sub data.

6. The electronic device of claim 1, wherein the error detection module comprises a first error detection module and a second error detection module,
wherein the second error detection module is configured to detect errors in the data received from the nonvolatile memory device by comparing the data with delayed data, and
wherein the first error detection module is configured to detect errors in the data received from the nonvolatile memory device in the units of the size of the cache line of the cache memory.

7. The electronic device of claim 1, wherein the MCU module comprises a nonvolatile memory interface module, and
wherein the error detection module is configured to output a retry trigger signal to the nonvolatile memory interface module based on a presence of an error in the data received from the nonvolatile memory device.

8. The electronic device of claim 7, wherein the MCU module is configured to receive a corresponding data set that includes the data received from the nonvolatile memory device in which the error is detected, based on the retry trigger signal.

9. The electronic device of claim 1, wherein the MCU module comprises a control logic circuit configured to interpret and execute a set of instructions included in the data received from the nonvolatile memory device.

10. The electronic device of claim 1, wherein the nonvolatile memory device comprises serial NOR flash memory that supports an execute in place (XiP) function.

11. An operating method of a micro controller unit (MCU) module configured to be included in a vehicle electronic device, the operating method comprising:
starting booting of the MCU module;
receiving data from a nonvolatile memory device external to the MCU module;
prior to completion of booting of a cache memory of the MCU module, transmitting, by the MCU module, the data received from the nonvolatile memory device to a control logic circuit of the MCU module through a second data path;
based on the completion of the booting of the cache memory, transmitting, by the MCU module, the data received from the nonvolatile memory device to the control logic circuit of the MCU module through a first data path; and
detecting, by the MCU module, errors in the data received from the nonvolatile memory device in units of a size of a cache line of the cache memory.

12. The operating method of claim 11, comprising detecting, by the MCU module, errors in the data received from the nonvolatile memory device by comparing the data received from the nonvolatile memory device with delayed data.

13. The operating method of claim 12, wherein transmitting the data received from the nonvolatile memory device through the second data path comprises transmitting the data received from the nonvolatile memory device through the second data path based on a comparison result of the data and the delayed data.

14. The operating method of claim 11, wherein the first data path is a data path that passes through the cache memory, and the second data path is a data path that bypasses the cache memory.

15. The operating method of claim 11, wherein the data comprises a set of instructions for interpretation and execution by the control logic circuit of the MCU module.

16. The operating method of claim 11, wherein the nonvolatile memory device comprises serial NOR flash memory that supports an XiP function.

17. A micro controller unit (MCU) module configured to be included in a vehicle electronic device, the MCU module comprising:
cache memory; and
an error detection module configured to detect errors in data received from a nonvolatile memory device external to the MCU module in units of a size of a cache line of the cache memory.

18. The MCU module of claim 17, further comprising:
a control logic circuit configured to output a selection signal; and
a selection module configured to, based on the selection signal:
provide data on which an error detection operation has been performed, to the control logic circuit, from the error detection module, or
provide data stored in the cache memory to the control logic circuit.

19. The MCU module of claim 18, further comprising a cache controller including the cache memory,
wherein the cache controller is configured to, after performing an initialization operation, output a selection trigger signal to the control logic circuit, and
wherein the control logic circuit is configured to output the selection signal in response to the selection trigger signal.

20. The MCU module of claim 19, wherein the cache controller is configured to output the selection trigger signal to the control logic circuit based on all valid bits of the cache memory having a predetermined bit value.
